(19) United States
(12) Patent Application Publication
(10) Pub. No.: US 2020/0034646 A1
(43) Pub. Date: Jan. 30, 2020

(54) Unmanned Aerial Localization and Orientation

(71) Applicant: Exyn Technologies, Philadelphia, PA (US)

(72) Inventors: Xuchu Ding, Philadelphia, PA (US); Denise Wong, Philadelphia, PA (US)

(21) Appl. No.: 16/520,793

(22) Filed: Jul. 24, 2019

Related U.S. Application Data
(60) Provisional application No. 62/702,543, filed on Jul. 24, 2018.

(51) Int. Cl. G06K 9/32; B64C 39/02; G07C 5/00; G05D 1/06; H04W 4/02

(52) U.S. Cl. CPC G06K 9/3241; B64C 39/024; G07C 5/008; B64C 2201/18; H04W 4/027; B64C 2201/127; G05D 1/0676

(57) ABSTRACT

Certain embodiments of the disclosure can include systems and methods for robotic localization and orientation. The systems and methods can include identification of a landmark, such as a landing pad, by a sensor of an unmanned vehicle. The systems and methods can include acquiring coordinates of the landmark; and determining a self-position, by the unmanned vehicle, based on the coordinates of the landmark. The systems and methods can also include determining the position of an object based on the coordinates and the self-position.

### CROSS REFERENCE TO RELATED APPLICATIONS

The present application claims the benefit of U.S. provisional patent application No. 62/702,543 filed on 24 Jul. 2018, the disclosure of which is incorporated in its entirety herein by reference.

### FIELD OF INVENTION

The present disclosure relates to autonomous localization and orientation by unmanned aerial vehicles.

### BACKGROUND

Presently, aerial vehicles use known fiducials for both localization and mapping. That is, predetermined landmarks must be programmed into an aerial robotic vehicle prior to flight in order to plot and navigate a course or route. Existing technologies for planning and navigating aerial routes by unmanned vehicles do not utilize data observed by multiple vehicles to create maps with more accuracy and higher coverage, do not take into consideration common landmarks, such as landing pads or survey points, and do not adjust or plan flight paths such that multiple landmarks such as landing pads are identified.

### SUMMARY OF THE INVENTION

Some or all of the above needs and/or problems may be addressed by certain embodiments of the disclosure. Certain embodiments can include systems and methods for autonomous aerial localization. According to one embodiment of the disclosure, there is disclosed a method. The method can include identifying a map element, such as a landing pad, with a sensor of an unmanned aerial vehicle. The method can include acquiring positional coordinates of the map element, and determining a position of the unmanned aerial vehicle relative to the coordinates of the map element. The method can also include determining the location of an object within range of the vehicle sensor, based at least in part on the coordinates of the map element and the position of the unmanned vehicle.

According to another embodiment of the disclosure, there is disclosed a system. The system can include a sensor, a microprocessor, and computer memory. The system can execute a computer program that can identify a map element within range of one of the sensors, and can acquire the coordinates of the map element. The system can determine the position of the unmanned vehicle from which it is executing, relative to the coordinates of the map element. The system can also determine the location of an object within range of the sensors, based at least in part on the coordinates and the position of the vehicle.

Other embodiments, systems, methods, aspects, and features of the disclosure will become apparent to those skilled in the art from the following detailed description.

### BRIEF DESCRIPTION OF DRAWINGS

The detailed description is set forth with reference to the accompanying drawings, which are not necessarily drawn to scale. The use of same reference numbers in different figures indicate similar or identical terms.

FIG. 1 is a flow diagram of an example method of unmanned aerial vehicle localization, according to an embodiment of the disclosure.

FIG. 2 illustrates an example functional block diagram representing an example aerial localization system, according to an embodiment of the disclosure.

FIG. 3 illustrates a collaboration mission between multiple robots leveraging known map elements according to an embodiment of the disclosure.

### DETAILED DESCRIPTION OF THE PREFERRED EMBODIMENTS

In order that the present invention may be fully understood and readily put into practical effect, there shall now be described by way of non-limiting examples of preferred embodiments of the present invention, the description being with reference to the accompanying illustrative figures.

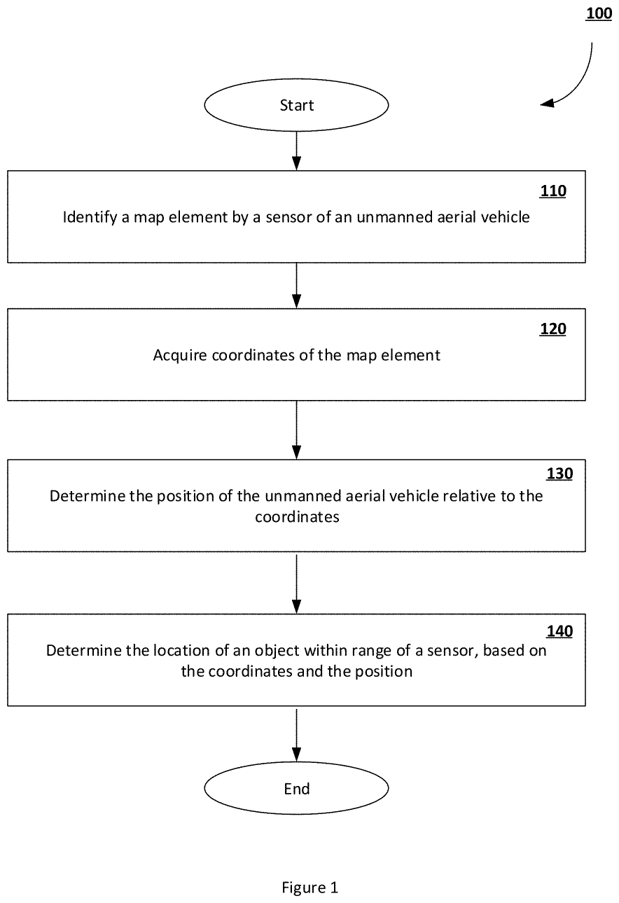

Certain embodiments herein relate to autonomous localization by an unmanned aerial vehicle (UAV). Accordingly, a method can be provided to orient a UAV. For example, FIG. 1 is a flowchart illustrating a process 100 for localizing and orienting a UAV, according to various aspects of the present disclosure. The process 100 can begin at block 110. At block 110, process 100 can identify a map element by a sensor of a UAV. The map element can be a landing pad or other landmark within range of one or more sensors of the UAV. In some embodiments, the map element can be a navigation marker or other object, and the map element can be an original component of the map (inspection or global) or a recently identified object. The map element can be static or dynamic. For example, landing pads are often fixed at a particular location, and the UAV can use the known location of the landing pad as a directional and positional reference by measuring the UAV's position relative to the landing pad or other map element. However, other map elements and sometimes landing pads, can also be dynamic and the dynamic or updated position of the map element can be communicated to the UAV for continued reference. In some embodiments, a map element such as a landing pad can be identified by a unique code so landing pads can be differentiated from one another.

The UAV can include at least one sensor for detection within the UAV's environment. The sensor(s) can include one or more optical cameras mounted on the UAV, or incorporated into the structure of the UAV. In some embodiments, multiple cameras can be positioned for viewing in different directions away from the UAV. In some embodiments, the cameras can include additional sensors such as low-light or night vision, or heat detection. The sensor(s) can also include radio frequency identification detection (RFID), and can receive information from a map element or other object via one or more radio antennae of the UAV. In some embodiments, the UAV can transmit information via RFID from its radio antenna(e). The sensor(s) can also include light detection and ranging (LiDAR), and can receive information from a map element or other object via one or more LiDAR antenna(e). The UAV can share information gathered via its sensors with other UAVs and with central databases.

Process 100 can include actuating a motor to affect a position and/or orientation of the UAV. The UAV can include many motors, including a motor for each propeller. The UAV can also include motors for steering, lift, and acceleration. For example, a UAV with flaps or ailerons can control those mechanisms via at least one motor. In turn, process 100 can control the UAV by actuating one or more of those steering motors, as well as the propeller motors.

At block 120, the UAV can acquire information about the map element through several methods. The information can be acquired from a central database, from the UAV's own computer memory, from the computer memory of other UAVs, and from the map element itself. In some embodiments, the information can be communicated virtually simultaneously from the measuring UAV to the central data storage and other UAVs. The map element can include a code, such as a bar code or QR code, which can be read by a sensor of the UAV. In some embodiments, the UAV can include an optical camera that can recognize and interpret the code. The cameras and other sensors can be linked to databases and programs, local and remote, that can provide code translation for any codes the UAV may encounter via the map element or other object during the UAV's operation, for example during an inspection mission. The code can include information such as an identifier of the map element, as well as coordinates and position of the map element, which can be absolute and/or relative. A map element is sometimes referred to as feature data, and it can be spatially registered using the position and orientation estimated by the UAV. In some embodiments, the accuracy of measured positions and dimensions can be improved via an optimization algorithm. Multiple measurements of the same feature data can provide increased accuracy of the measured position of the feature data. In one embodiment, simultaneous localization and mapping (SLAM) can be used by leveraging information such as commonly identifiable landing pads. In some embodiments, the code can include pieces of information about the map element, which the UAV can combine with other pieces of information about the map element, including information from remote databases or from the UAV's own memory. In some embodiments, the UAV can include in its memory, prior to operation, the coordinates of map elements which it may encounter during operation, as well as an identification of those map elements. The UAV can then, when it receives the ID of the map element upon encountering it during operation, associate the ID with the coordinates stored in the UAV memory. Using the stored information and the data acquired during the inspection mission, the UAV can generate a map, both in two dimensions and in three dimensions, of the inspection route. The generated map can be of dense or sparse detail and can include a variety of data types. In some embodiments, the map can be point clouds collected by a LiDAR unit, it can be inventory tags scanned by the UAV during flight, and it can be a combination of these along with other data types. Process 100 can also generate a global map based at least in part on one or more inspection maps. A global map can include feature data aligned into a common frame of reference. In some embodiments, the location of at least one landing pad in the global frame of reference is known. For example, the origin of the global frame of reference can be fixed at the location of the first landing pad.

At block 130, process 100 can determine the position of the UAV relative to the coordinates of the map element. In some embodiments, the UAV can use one or more LiDAR antennae and sensors to measure distance between the UAV and the map element. In some embodiments, the UAV can use one or more RFID antennae and sensors to measure distance between the UAV and the map element. In some embodiments, the UAV can use a combination of the LiDAR, RFID, and optical camera sensors, as well as locally and remotely stored information, to acquire information to measure distance between itself and the map element.

At block 140, process 100 can determine the location of an object within range of at least one of the sensors of the UAV. The UAV can measure a distance between the UAV and the object, for example, in a similar manner to how the UAV measures distance between itself and a map element. In some embodiments, the UAV can position itself over or near an object and simply measure distance between the UAV and the map element. This can be useful, for example, when high precision on the landing location is necessary. In one embodiment, this can be used for landing the UAV on a charging station, including on a wireless charging station. Using this measurement, the UAV can determine the location of the object by combining the coordinates with the distance of its own position. In some embodiments, the UAV can measure orientation and position between the UAV and the object and, also using the coordinates of the map element, can then calculate the coordinate location of the object. The UAV can triangulate the location of the object using any one of, or any combination of, the information available to the UAV via its own sensors, computer memory, and communication capabilities. The UAV can utilize multiple reference coordinate systems. In some embodiments, the position of an object can be described as the distance along three orthogonal axes. Depending on the reference or coordinate system used by the UAV, the position of an object or map element can be differently described with respect to the system. In some embodiments, a position can be defined by a three-dimensional location along three orthogonal axes, and an orientation can be defined as a rotation about the same three orthogonal axes. The UAV can also use relative constraints, such as the number of times an object or map has been measured, in order to weigh information more heavily (more consistent readings) or less heavily (fewer consistent readings). In some embodiments, new measurements or other information can lead process 100 to update or correct the position of an object or map element. Process 100 can then correct the stored information, both centrally and locally to the UAV, and update any other UAVs that may have an interest in the corrected information.

In addition to locating the UAV relative to a map element or object, process 100 can also calculate absolute coordinates of the UAV. The ability to anchor the position and orientation of the UAV to a fixed location in known maps can provide additional information on the immediate and wider environment of the UAV. This information can be used as an additional constraint by process 100 in generating a map such as, for example, for optimizing a SLAM algorithm. One of the advantages of fusing individual maps into a global map of constraints is to minimize errors for all constraints in the system. An optimization can be undertaken by process 100 both while the UAV is flying and while it is resting. In some embodiments, the microprocessors of the UAV can perform all the operations of optimization. In other embodiments, remotely located microprocessors can assist in the optimization, or they can perform all of the optimization. In flight, a UAV can obtain feature data from fiducial, or known, map elements. This feature data, including position and orientation, can be collected and recorded relative to the takeoff pose. If the UAV detects another map element, such as another landing pad, the feature data can be correlated to this new map element in addition to the original map element relation. In this way, a more detailed map of a larger area can be generated. Any errors achieved, for example, through imprecise sensor data or computational rounding, can be minimized by the multiple (or many) loops measured by UAVs. In some embodiments, errors can also be minimized by solving a standard nonlinear least square optimization problem. This can be achieved by the UAV microprocessors, remotely located microprocessors, or both.

In some embodiments, a UAV can operate in conjunction with other UAVs. The collaboration can be for the purpose of mapping a single inspection course, for mapping multiple inspection courses, and for mapping a global course. The multiple UAVs can communicate in real-time or near real-time, such that a UAV can correct its flight path based on information newly acquired from one or more other UAVs. In some embodiments, information acquired by a UAV can first be communicated to a central data location before being communicated to another UAV. In some embodiments, multiple UAVs can operate together in virtual simultaneity, such that any connected UAV can essentially be operating with the sensor range of all the connected UAVs. This can provide a much wider map area to the individual UAV to increase its awareness of additional landing pads and other map elements.

The operations described and shown in process 100 of FIG. 1 can be carried out or performed in any suitable order as desired in various embodiments of the disclosure, and process 100 can repeat any number of times. Additionally, in certain embodiments, at least a portion of the operations can be carried out in parallel. For example, block 110 and block 120 can take place at a single time, according to some embodiments of the disclosure. Furthermore, in certain embodiments, fewer or more operations than described in FIG. 1 can be performed.

Process 100 can optionally end after block 140.

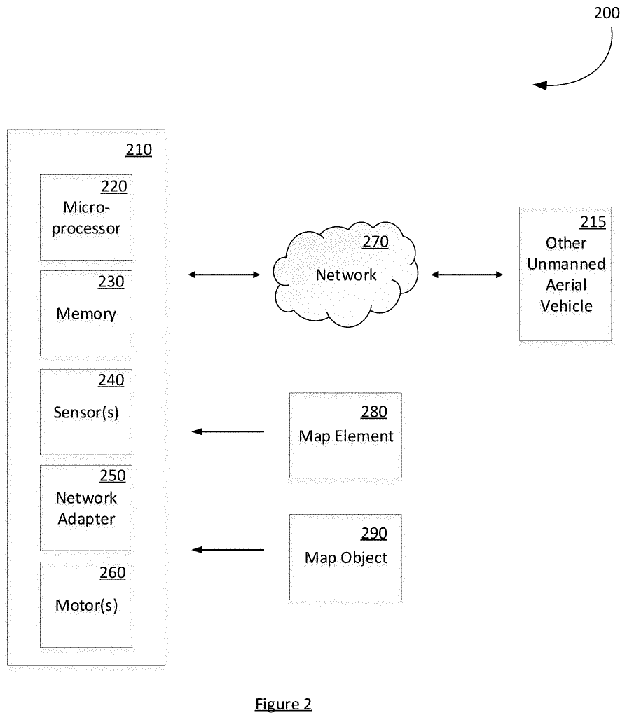

According to another embodiment of the disclosure, there is provided a system. For example, system 200 can be provided for localization and orientation of a UAV. FIG. 2 depicts an example block diagram of system 200. System 200 can include UAV 210, which can include one or more microprocessors 220. The microprocessors can be of any suitable type and ability for executing the algorithms and processes of the UAV and the mapping programs. System 210 can also include at least one memory 230 accessible by microprocessor 220. Memory 230 can include flash memory, RAM, ROM, removable storage, optical and magnetic storage, and any other suitable means for storing programs and information, and small enough to fit in UAV 210. Memory 230 can store computer-readable instructions accessible by the one or more microprocessors 220, which can then execute the computer-readable instructions. In some embodiments, UAV 210 can include a network adapter 250 for communication with outside resources and/or other UAVs 215. Network adapter 250 can include more than one physical adapter in order to communicate with multiple types of networks, for example, Wi-Fi, LAN, modem, and Bluetooth. UAV 210 can include one or more sensors 240 to identify objects and to aid in navigation and control of the vehicle. The sensors 240 can be of any suitable type in detecting changes in the flight and attitude of the UAV 210, and can also be of any suitable type for detecting objects 290 or map elements 280 within range of the sensors 240. In some embodiments, the sensors 240 can include RFID, LiDAR, and optical detection, and can identify an object 290 or map element 280 via the sensors 240. In one embodiment, a map element 280 such as a landing pad can include a QR code within view of a camera 240 of UAV 210. With this identification of landing pad 280, UAV 210 can then calculate its own position as well as the position of an object 290 by determining the distance and position difference between itself 210, the object 290, and the landing pad 280. Differences in distance and position can be measured along three orthogonal axes, and they can be measured in spherical coordinates. In some embodiments, a map element 280 such as a landing pad can transmit a radio frequency identification which can be detected by an RFID sensor 240 of UAV 210.

In some embodiments, UAV 210 can identify a map element 280, such as a landing pad, that is within range of a sensor 240. UAV 210 can acquire the coordinates of that map element 280, for example via the code or message provided by the map element 280. In some embodiments, the code can be a bar code or QR code, and it can be detected by a visual spectrum camera of UAV 210. In some embodiments, an arrangement of spheres can be detected by UAV 210, for example, via a LiDAR sensor 240. The LiDAR sensor 240 can be operable to identify a landing pad via its unique arrangement of spheres. In some embodiments, color patterns or other uniquely identifying patterns, for example retro-reflective markers, can serve as identification for a particular landing pad. UAV 210 can also identify a landing pad 280 by a combination of three-dimensional features detected by a LiDAR sensor 240 and/or an optical camera 240. Landing pads and other map elements can incorporate multiple methods of identifying themselves; and the memory 230, sensors 240, and cooperation with other aerial vehicles 215 can detect these identifiers, both individually and in conjunction.

In some embodiments, UAV 210 can acquire the coordinates of map element 280 from a central data storage or from another unmanned aerial vehicle 215. In some embodiments, UAV 210 can acquire the coordinates and other information from other vehicles 215 substantially contemporaneously with when the other vehicle(s) 215 are acquiring the information. In this way, any connected vehicle can operate with the combined information of all the connected vehicles. UAV 210 can determine its position and coordinates relative to the location of the map element 280. By determining its own position and by knowing the coordinates of the map element 280, UAV 210 can then determine the location of another object 290 that is within range of one of its sensors 240. In some embodiments, UAV 210 can acquire the coordinates of its starting point landing pad 280 and, upon acquiring coordinates during flight of a second (or third or more) landing pad, UAV 210 can land at the other landing pad. Similarly, the vehicle that started its flight at UAV's 210 ending point, can then end its own flight at UAV's 210 starting point, or any other landing pad whose coordinates were acquired by its own sensors 240.

In some embodiments, in order to navigate its desired route, UAV 210 can actuate one or more of its motors 260 to adjust its speed and heading to arrive at the desired location. To execute a mission, system 200 can plan a dynamically feasible trajectory from the current position of UAV 210 to its next waypoint. System 200 can calculate the required motor 260 control outputs to achieve the desired UAV 210 behavior to follow the trajectory. Executing the controller inputs, estimating the state (position and orientation) of the UAV 210, and utilizing the applicable map(s) of the environment—and performing all this recursively—ensures efficient UAV 210 operation and map accuracy. Motors 260 can run the propellers and can be sped up or slowed down depending on the desired effect. In some embodiments, a subset of all the motors 260 can speed up some of the propellers while the other propellers remain the same speed, in order to effectuate a change in direction of UAV 210. In some embodiments, motors 260 can be actuated by system 200 in order to adjust a flap, aileron, elevator, or other vehicle guidance of UAV 210.

In some embodiments, system 200 can generate an inspection map of its current or immediate route. The inspection map can include map elements 280 that have come within range of at least one of UAV's 210 sensors 240 during its flight. The inspection map can also include objects 290 that have come within range of at least one of UAV's 210 sensors 240 during its flight. System 200 can also include in the inspection map information acquired from one or more remote databases, as well as from one or more other aerial vehicles 215. A LiDAR sensor 240 can scan from UAV 210 and can accumulate and combine scans. In some embodiments, the LiDAR sensor 240 can scan approximately 15,000 points in each scan, which can take about one-twentieth ( 1/20) of a second per scan, and can map the three-dimensional path of the UAV 210. The UAV 210 can be represented in a global fixed coordinate frame, for example, and can be represented using relative coordinates, among other possible means of representation. Scans can be combined, or fused, to generate a partial or complete inspection map. Using all this information or a subset of it, system 200 can then generate a more detailed inspection map. In other embodiments, though, a more sparse inspection map may be desired, for example in a map including only feature data.

In some embodiments, system 200 can generate a global map based on one or more inspection maps. System 200 can also include in its global, or fusion, map information contemporaneously received from one or more aerial vehicles, as well as additional information that can be available from one or more connected databases. In the fusing, or combining, of maps and data into a global map, system 200 can convert a constituent map into a collection of relative constraints. Each feature data can be represented by its orientation, or pose, where the feature data is taken, as well as a three-dimensional location relative to this orientation. Each captured pose can be represented as a constraint between the previous pose and the next pose. One example of how system 200 can compute this constraint is by comparing successive scans to calculate the relative motion between each scan. Additionally, the distance traveled can be calculated based on motor outputs of the system 200, and using a dynamical model of the system, for example, to compute the predicted motion traveled given the motor commands. This chronological arrangement of orientations can serve as a map of three-dimensional constraints. In some embodiments, if the global map is empty, the first map of constraints can be used as the global map of constraints. Within a map, both inspection and global, landing pads 280 can be identified for reference by a UAV 210. In some embodiments, maps can be combined or fused based on one or more landing pads 280. The pose or orientation of the landing pad 280 from the flight path of a first UAV 210 can differ from the pose or orientation of the same landing pad 280 from a flight path of a second (or other multiple) UAV 210. In this way, a broader map and a broader approach to the given landing pad 280 can be generated from these relative constraints. While a global map can be generated by fusing inspection maps, global maps can also be generated by converting relative feature data into a three-dimensional location. In embodiments where a landing pad 280 can be identified by a fixed reference, all other objects 290 and map elements 280 within the same map can similarly be associated with a fixed reference. One result of these calculations can be a map of three-dimensional locations for all feature data from individual maps.

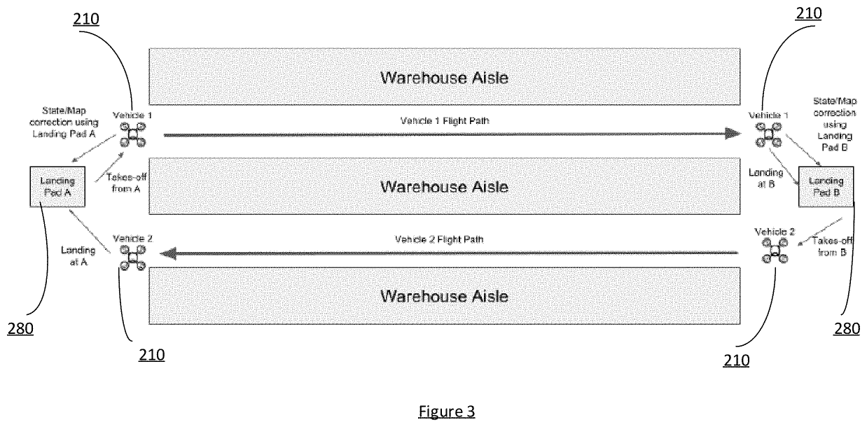

With reference now to FIG. 3, a first UAV 210 can take off from landing pad A 280 to begin its trip through a warehouse aisle, for example. During its flight, the first UAV 210 can correct its inspection map and/or its flight path based on reference to landing pad A 280 as well as measurements from its sensors 240. Similarly, a second UAV 210 can take off from landing pad B 280 for its own trip through a warehouse aisle, for example, that may be the same or different aisle as the first UAV 210. The second UAV 210 can also correct its own path based on its measurements and the coordinates it has for landing pad B 280. Upon reaching a desired destination, for example the end of the warehouse aisle, and upon finding landing pad A 280, the second UAV 210 can then end its trip and land at landing pad A 280. Similarly, upon the first UAV 210 reaching its desired destination, and upon finding landing pad B 280, the first UAV 210 can then land at landing pad B 280. In this way, usage of the unmanned aerial vehicles can be more efficient since neither UAV here would need to make a wasteful return trip, merely for the sake of returning to one particular landing pad. These and other advantages can be gained through the dynamic identification of map elements, such as landing pads, by aerial vehicles in flight.

System 200 can plot a course for UAV 210 prior to takeoff from a landing pad 280. System 200 can access its own, and other, databases to plan the route for UAV 210. The route, or mission, can be loaded into the memory of UAV 210 and the mission can be stored elsewhere and accessed remotely by a network adapter 250 of UAV 210. As UAV 210 executes its mission, UAV 210 can detect, via sensors 240, objects 290 and map elements 280 that are either included in the plotted course or are not included in the plotted course. UAV 210 can communicate any updates of the course to other aerial vehicles 215 and to central databases. System 200 can execute the mission by actuating the motors 260 necessary to follow the planned route, and to avoid any obstacles impeding the route of UAV 210. Any differences between the planned mission and the executed mission, such as new feature data, can be communicated to centralized databases and other aerial vehicles 215 to be used for correction of future missions and other purposes. When a mission is complete, UAV 210 can then determine which landing pad 280 to target. UAV 210 can choose an appropriate landing pad 280 based on proximity, availability, and other factors, such as convenience for the next mission. System 200 can repeat this cycle of mission planning, execution, and correction, as long as UAV 210 has power to operate.

In some embodiments, it can be beneficial to plan one or more trajectories that allow multiple landing pads to be identified in order to minimize any potential error in the global map when fusing multiple maps together. Accuracy of a map can be a function of the distance between the known locations of map elements. For example, this distance can affect the accuracy of the alignment between different maps when those maps are fused together. Map elements, such as landing pads, can be placed in specific locations to ensure map accuracy. For example, if there is sensor measurement error of three centimeters (to use one common error), landing pads can be placed more than six meters apart to ensure map accuracy of one meter or less. If this exemplary level of map accuracy is desired, trajectories can be planned such that the route of UAV 210 includes at least two map elements (e.g. landing pads) which are sufficiently far apart.

As desired, embodiments of the disclosure may include a system with more or fewer components than are illustrated in the drawings. Additionally, certain components of the system may be combined in various embodiments of the disclosure. The systems described above are provided by way of example only.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method for controlling and orienting an unmanned aerial vehicle, the method comprising:
identifying a map element within range of a sensor of the unmanned aerial vehicle;
acquiring coordinates of the map element;
determining a position of the unmanned aerial vehicle relative to the coordinates of the map element; and
determining a location of an object within the range of the sensor, based at least in part on the coordinates and the position.

2. The method as recited in claim 1, wherein acquiring the coordinates comprises acquiring data from at least one of a remote database or another unmanned aerial vehicle.

3. The method as recited in claim 2, wherein the unmanned aerial vehicle acquires the data substantially contemporaneously with determination by the other unmanned aerial vehicle.

4. The method as recited in claim 1, wherein the sensor comprises at least one of an optical camera, LiDAR detection, and RFID detection.

5. The method as recited in claim 1, wherein the map element comprises at least one landing pad.

6. The method as recited in claim 1, further comprising actuating at least one motor to affect a position and velocity of the unmanned aerial vehicle.

7. The method as recited in claim 1, further comprising generating an inspection map of a course utilized by the unmanned aerial vehicle.

8. The method as recited in claim 7, further comprising ensuring a level of accuracy of the inspection map based at least in part on sensor error and locations of map elements.

9. The method as recited in claim 7, further comprising communicating, by the unmanned aerial vehicle, data about the course to a remote location.

10. The method as recited in claim 7, further comprising generating a global map based on at least one inspection map.

11. A system for autonomous aerial localization, the system comprising:
at least one sensor;
at least one microprocessor; and
at least one memory storing computer-readable instructions, the at least one microprocessor operable to access the at least one memory and execute the computer-readable instructions to:
identify a map element within range of the at least one sensor;
acquire coordinates of the map element;
determine a self-position relative to the coordinates of the map element; and
determine a location of an object, based at least in part on the coordinates and the position.

12. The system as recited in claim 11, wherein the coordinates are acquired from at least one of a remote database or another unmanned aerial vehicle.

13. The system as recited in claim 12, wherein the coordinates are acquired substantially contemporaneously by the unmanned aerial vehicle and the other unmanned aerial vehicle.

14. The system as recited in claim 11, wherein the sensor comprises at least one of an optical camera, LiDAR detection, and RFID detection.

15. The system as recited in claim 11, wherein the map element comprises at least one landing pad.

16. The system as recited in claim 15, wherein the map elements comprises at least two landing pads, the at least two landing pads detectable by the at least one sensor based on a planned trajectory.

17. The system as recited in claim 11, wherein the computer-readable instructions are further operable to actuate at least one motor to affect a position and velocity of the unmanned aerial vehicle.

18. The system as recited in claim 11, wherein the computer-readable instructions are further operable to generate an inspection map of a course utilized by the unmanned aerial vehicle.

19. The system as recited in claim 18, wherein the computer-readable instructions are further operable to communicate, by the unmanned aerial vehicle, data about the course to a remote location.

20. The system as recited in claim 18, wherein the computer-readable instructions are further operable to generate a global map based on at least one inspection map.
